(19) United States
(12) Patent Application Publication
(10) Pub. No.: US 2024/0282326 A1
(43) Pub. Date: Aug. 22, 2024

(54) HARMONIC COEFFICIENT SETTING MECHANISM

(71) Applicant: Resonant Cavity LLC, Minneapolis, MN (US)

(72) Inventor: James Patrick Flanagan, Minneapolis, MN (US)

(21) Appl. No.: 18/111,286

(22) Filed: Feb. 17, 2023

(51) Int. Cl. G10L 21/0232; G10L 25/90; G10L 25/93

(52) U.S. Cl. CPC G10L 21/0232; G10L 25/90; G10L 25/93

(57) ABSTRACT

A computer implemented method includes receiving a monophonic voice signal. The fundamental frequency of the voice signal is estimated and corresponding harmonics are identified. An interface is generated to receive adjustable amplification coefficient selections for the harmonics. The harmonics are amplified with received amplification coefficient selections and recombined with the high frequency voice signal components to provide an enhanced output signal.

### BACKGROUND

Hupman vocal sounds can be divided into two primary types: voiced and unvoiced. Voiced sounds are produced when the vocal cords open and close regularly as air is pushed by the lungs through the vocal cords and into the vocal tract. Voiced sounds have a perceptible pitch or note. This pitch, also called the fundamental frequency, is determined by the rate at which the vocal cords vibrate. Examples include vowel sounds and voiced consonants such as /m/ and /n/. Voiced human sounds may contain a non-pitched noise component, such as the buzzing sound produced at the front of the mouth for the phoneme /z/, but they are defined by their pitched component produced by the regular vibration of the vocal cords. Unvoiced sounds, in contrast, do not entail use of the vocal cords and have no singular pitch. Examples of unvoiced sounds include the phonemes /s/, /p/, and /k/.

According to the principles of Fourier analysis, any sound signal can be analyzed as the sum of sine waves with different discrete frequencies, amplitudes, and phases. In voiced human speech, the frequencies of sine waves, or sinusoids, that constitute the pitched component of a sound exist at integer multiples of the sound's fundamental frequency. These sine waves at integer multiples of the fundamental are referred to as “partials” or “harmonics.” The fundamental frequency is also referred to as the first harmonic. For example if the fundamental frequency has a sine wave of 100 Hz, the succeeding harmonics would be 200 Hz, 300 Hz, 400 Hz, etc.

Patterns in the relative amplitude of harmonics contribute significantly to a sound's sonic identity or timbre. For example, the clarinet produces a spectrum in which even-numbered harmonics are almost absent in its lower chalumeau register, which gives the clarinet its characteristic hollow sound. Likewise, organ pipes sharing the same fundamental pitch can produce different timbres because pipes of differing width distribute energy differently across harmonics. Wider pipes concentrate energy in the lower harmonics and vice versa. In Tuvan throat singing, vocalists amplify isolated groups of harmonics to achieve unique and compelling sounds.

Prior systems are able to classify whether part of a human speech signal is voiced or unvoiced and if it is voiced, estimate its fundamental frequency. Prior systems can also decompose a signal into a set of sinusoids characterized by their frequency, amplitude, and phase, modify characteristics of these sinusoids, and resynthesize a time domain signal from the modified data.

### SUMMARY

A computer implemented method includes receiving a monophonic voice signal. The signal is classified as either voiced or unvoiced. If it is voiced, a fundamental frequency is estimated and corresponding harmonic frequencies are identified. An interface is presented to receive user-adjusted amplification coefficients for the harmonics. The harmonics are amplified by received amplification coefficients and recombined with the non-harmonic signal to provide a modified output signal.

### BRIEF DESCRIPTION OF THE DRAWINGS

FIG. 1 is a block flow diagram of a system for adjusting harmonic amplification of a voice signal according to an example embodiment.

FIG. 2 is a block flow diagram for combining amplified harmonics with higher frequency components of a voice signal according to an example embodiment.

FIG. 3 is a flowchart illustrating a computer implemented method for adjusting harmonic amplification of a voice signal according to an example embodiment.

FIG. 4 is a flowchart of a computer implemented method of selecting the fundamental frequency according to an example embodiment.

FIG. 5 is a flowchart illustrating a computer implemented method of recombining the voice signal with the amplified harmonics.

FIG. 6 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Prior systems are able to classify whether part of a human speech signal is voiced or unvoiced and if it is voiced, an estimate of the voiced human speech's fundamental frequency is made. Prior systems can also decompose a signal into a set of sinusoids characterized by their frequency, amplitude, and phase, modify characteristics of these sinusoids, and resynthesize a time domain signal from the modified data.

An improved harmonic amplification system classifies signal segments as voiced or unvoiced, estimates the fundamental frequency of a monophonic voice signal, identifies harmonic frequencies, disregards non-harmonic sinusoids, and provides an interface for adjusting amplification parameters for each harmonic up to a predetermined maximum harmonic number. The ability to adjust the amplification parameters provides a means of creating enhanced, strange, otherworldly, or otherwise aesthetically pleasing sounds.

The harmonic amplification system combines the amplified harmonics with the high frequency noise components of the original voice signal to produce an output for rendering via speakers or recording for later rendering.

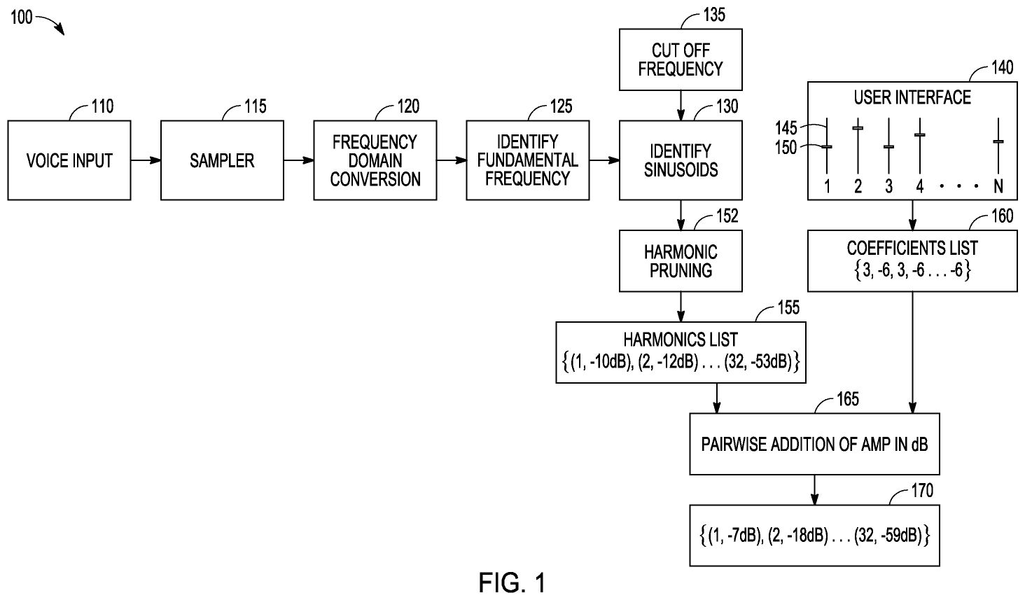

FIG. 1 is a block flow diagram of a system 100 for adjusting harmonic amplification of a voice signal according to an example embodiment. System 100 receives a monophonic voice signal at an input 110. The voice input signal is sampled at a sampler 115 and converted to a frequency domain signal at a converter 120. In one example, analysis may be performed for windows of 23 msec with 1024 samples per window. These segments of audio are also called frames in the literature. Other frame lengths and sampling rates may be used in further examples. The frame length and sample rate may be selected based on processing power available and should be sufficient to provide a desired final output signal quality.

The frame of audio is classified as either unvoiced or voiced. In one embodiment, the classifier is a logistic regression model that is trained on labeled data to estimate voiced status using as inputs spectral centroid, RMS loudness of the frame, and maximum value of the autocorrelation function of the frame. Other criteria, such as zero-crossing rate, can be used to classify frames as voiced or unvoiced.

A fundamental frequency identifier 125 is used to identify the fundamental frequency from the frequency domain magnitude spectrum. A peak picking algorithm 130 identifies sinusoidal components in the frequency domain by searching for local peaks in the log magnitude spectrum. An exact estimate of the frequency of the sinusoid is computed by fitting a parabola to the peak and computing its apex. A harmonic assignment algorithm assigns each sinusoid a harmonic number by dividing the frequency of the sinusoid by the fundamental frequency and rounding to the nearest integer. If two sinusoids are assigned the same harmonic number, a winner is chosen by preferring the sinusoid that has the greatest weighted combination of log magnitude and proximity to the ideal harmonic frequency.

In one example, system 100 handles ambiguous cases where there are two more sinusoids that are both close to the ideal harmonic, selecting between the sinusoids. Both loudness and frequency distance to the ideal harmonic may be used to select a “winning” harmonic. This harmonic pruning, shown at 152, may be done by normalizing both and adding, selecting the highest aggregate, or loudness and frequency distance may be weighted before combining and selecting the highest aggregate. The output of harmonic pruning is the harmonic list 155 that includes information identifying each harmonic frequency and the amplitude of each harmonic.

In one example, sinusoids in the frequency domain are identified only up to a frequency value referred to as a harmonic cutoff frequency (HCF). The HCF is an estimate of the frequency at which the signal segment under analysis transitions from mostly sinusoidal, harmonic content to mostly noisy, inharmonic content.

A user interface 140 includes a line 145 for each harmonic component and a slider 150 to facilitate adjustment of an amplification parameter for each harmonic. N such lines and sliders are shown in FIG. 1, corresponding to the first N harmonics. A coefficient list 160 is generated based on the position of each slider 145 as set by a user. In further examples, user interface 140 may include dials, rotary knobs, or even a field to directly enter a number for each amplification parameter. In one example, the number may be from zero to 100, and may be used to vary the amplification parameter between zero and a maximum amount of amplification.

The harmonics list 155 and coefficient list 160 are combined in a pairwise addition of amplitudes in decibels (dB) at 165 to produce a set of amplified harmonics 170.

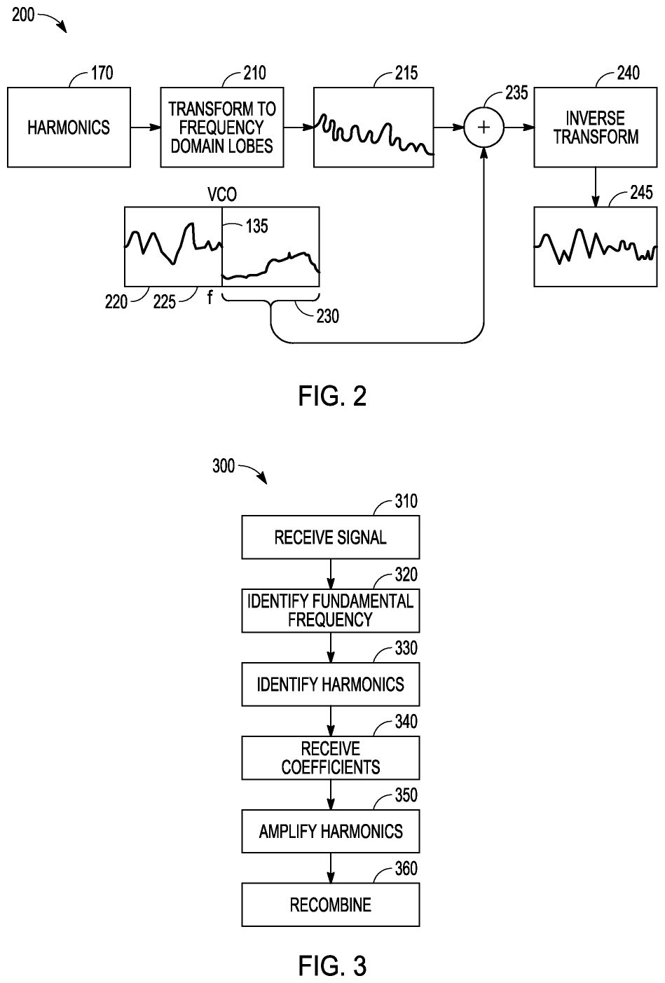

FIG. 2 is a block flow diagram of a system 200 for combining amplified harmonics 170 with higher frequency noise components of a voice signal according to an example embodiment. System 200 may be part of system 100 in one example. System 200 obtains amplified harmonics 170 and transforms 210 the information in amplified harmonics 170 into frequency domain lobes corresponding to the harmonics as shown at 215. The frequency domain components identified at 120 are represented graphically at 220 and include sinusoids 225 that are below the HCF 135 and higher frequency noise components 230 that are above the HCF 135.

An adder 235 is used to add the harmonics 215 and higher frequency components 230. The added signal is provided to an inverse transform 240 to generate a time domain output signal 245. In one example, a crossover fade is performed to smooth the transition at the HCF. The crossover fade provides for a smooth transition of sound about the HCF by gradually matching the amplification level of signals having frequencies at the HCF.

FIG. 3 is a flowchart illustrating a computer implemented method 300 for adjusting harmonic amplification of a voice signal according to an example embodiment. Method 300 begins at operation 310 by receiving a monophonic voice signal. The monophonic voice signal is a signal that represents a single voice that has been recorded or received from a live microphone. If multiple voices are present, the voices may be separated before being further processed.

At operation 320, a fundamental frequency of the voice signal is detected. Following identification of the fundamental frequency, harmonics of the fundamental frequency are determined at operation 330. Identifying harmonics may be performed by searching the magnitude spectrum for peaks, computing the frequency of those peaks, and dividing peaks below the HCF by the fundamental frequency. In one example, the HCF is at least 2500 Hz, but may be varied in further examples.

At operation 340 the adjustable amplification coefficient selections for the harmonics are received. The harmonics are amplified using the coefficients at operation 350 with user-specified amplification adjustments. The voice signal is recombined at operation 360 with the amplified harmonic frequency signals to generate an output signal.

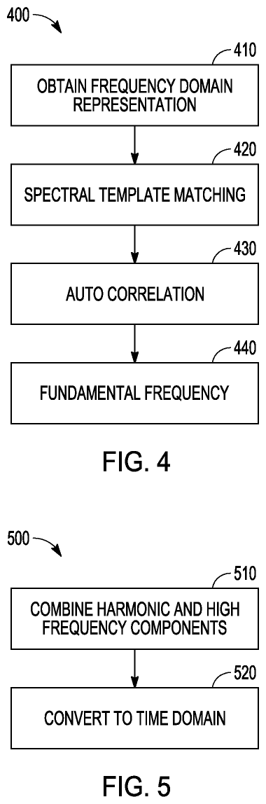

FIG. 4 is a flowchart of a computer implemented method 400 of estimating the fundamental frequency according to an example embodiment. At operation 410, a frequency domain representation of the input signal is obtained. The frequency domain representation may be obtained by performing an analog to digital conversion and performing a Fourier transform as previously described. At operation 420, a spectral template matching algorithm is used to produce an estimate of the fundamental frequency of the signal. Autocorrelation in the time domain may be used to refine the estimate at operation 430 and to select the frequency component as the fundamental frequency as shown at 440.

In further examples, the fundamental frequency of the signal may be estimated using any one or combination of several different methods, including but not limited to using an average magnitude difference function, an autocorrelation function, a spectral template matching on a magnitude spectrum of the signal, or pitch detection by peak-picking in the cepstral domain.

FIG. 5 is a flowchart illustrating a computer implemented method 500 of recombining the voice signal with the amplified harmonics. Method 500 begins at operation 510 by combining the modified harmonics' main lobes with a portion of the input signal having frequency components above the HCF to provide a time domain output at operation 520. The time domain output is generated by performing an inverse fast Fourier transform (FFT) on the combined amplified harmonics below the HCF and frequency components of the input signal above the HCF. In one example, a crossover fade between the amplified harmonics and the frequency components of the monophonic input signal above the HCF.

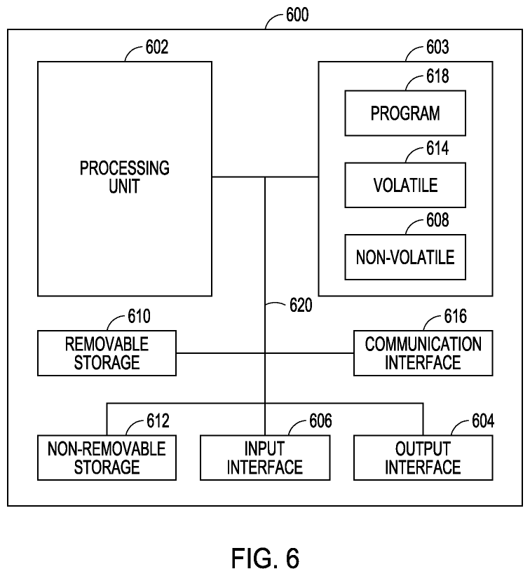

FIG. 6 is a block schematic diagram of a computer system 600 to adjustably amplify harmonics of a monophonic voice input and for performing methods and algorithms according to example embodiments. All components need not be used in various embodiments.

One example computing device in the form of a computer 600 may include a processing unit 602, memory 603, removable storage 610, and non-removable storage 612. Although the example computing device is illustrated and described as computer 600, the computing device may be in different forms in different embodiments. For example, the computing device may instead be a smartphone, a tablet, smartwatch, smart storage device (SSD), or other computing device including the same or similar elements as illustrated and described with regard to FIG. 6. Devices, such as smartphones, tablets, and smartwatches, are generally collectively referred to as mobile devices or user equipment.

Although the various data storage elements are illustrated as part of the computer 600, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 600 may include or have access to a computing environment that includes input interface 606, output interface 604, and a communication interface 616. Output interface 604 may include a display device, such as a touchscreen, that also may serve as an input device. The input interface 606 may include one or more of a touchscreen, touchpad, mouse, keyboard, camera, one or more device-specific buttons, one or more sensors integrated within or coupled via wired or wireless data connections to the computer 600, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 600 are connected with a system bus 620.

Computer-readable instructions stored on a computer-readable medium are executable by the processing unit 602 of the computer 600, such as a program 618. The program 618 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 618 along with the workspace manager 622 may be used to cause processing unit 602 to perform one or more methods or algorithms described herein.

### EXAMPLES

1. A computer implemented method includes receiving a monophonic voice signal, classifying a frame of input as voiced or unvoiced, detecting a fundamental frequency signal from the voice signal, identifying harmonics of the fundamental frequency signal, generating an interface to receive adjustable amplification coefficient selections for the harmonics, amplifying the harmonics with received amplification coefficient selections, and recombining high frequency noise components of the voice signal with the amplified harmonics.

2. The method of example 1 wherein detecting the fundamental frequency of vocal signal is performed using one or more of an average magnitude difference function, an autocorrelation function, spectral template matching on a magnitude spectrum of the signal, or pitch detection by peak-picking in the cepstral domain.

3. The method of example 2 wherein pitch detection is preceded by digitizing an analog voice signal and processing overlapping blocks or frames of samples.

4. The method of example 3 wherein a duration of each frame of samples comprises at least 20 msec and the number of samples comprises at least 1024.

5. The method of any of examples 1-4 wherein identifying harmonics includes dividing the frequency of sinusoids with a frequency below the harmonic cutoff frequency (HCF) by the fundamental frequency and rounding to the nearest integer.

6. The method of example 5 wherein the HCF is at least 2500 Hz.

7. The method of any of examples 5-6 wherein identifying harmonics further includes comparing and scoring sinusoids that are assigned to the same harmonic number by their relative amplitude and proximity in frequency to an ideal harmonic, and selecting a best scoring harmonic is selected for resynthesis.

8. The method of any of examples 5-7 wherein recombining the high frequency portion of the voice signal with the amplified harmonics includes combining the amplified harmonics with a portion of the monophonic input signal having frequency components above the HCF and converting the signal back to the time domain.

9. The method of example 8 wherein the time domain output is generated by performing an inverse fast Fourier transform (FFT) on the combined amplified harmonics and high frequency components of the monophonic input signal above the HCF.

10. The method of example 9 and further including performing a crossover fade between the amplified harmonics and the high frequency components of the monophonic input signal above the HCF.

11. A machine-readable storage device having instructions for execution by a processor of a machine to cause the processor to perform operations to perform any of the methods of examples 1-10.

12. A device includes a processor and a memory device coupled to the processor and having a program stored thereon for execution by the processor to perform operations to perform any of the methods of examples 1-10.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving a monophonic voice signal;
classifying a frame of input as voiced or unvoiced;
detecting a fundamental frequency signal from the voice signal;
identifying harmonics of the fundamental frequency signal;
generating an interface to receive adjustable amplification coefficient selections for the harmonics;
amplifying the harmonics with received amplification coefficient selections; and
recombining high frequency noise components of the voice signal with the amplified harmonics.

2. The method of claim 1 wherein detecting the fundamental frequency of vocal signal is performed using one or more of:
an average magnitude difference function;
an autocorrelation function;
spectral template matching on a magnitude spectrum of the signal; or
pitch detection by peak-picking in the cepstral domain.

3. The method of claim 2 wherein pitch detection is preceded by digitizing an analog voice signal and processing overlapping blocks or frames of samples.

4. The method of claim 3 wherein a duration of each frame of samples comprises at least 20 msec and the number of samples comprises at least 1024.

5. The method of claim 1 wherein identifying harmonics comprises dividing the frequency of sinusoids with a frequency below the harmonic cutoff frequency (HCF) by the fundamental frequency and rounding to the nearest integer.

6. The method of claim 5 wherein the HCF is at least 2500 Hz.

7. The method of claim 5 wherein identifying harmonics further comprises comparing and scoring sinusoids that are assigned to the same harmonic number by their relative amplitude and proximity in frequency to an ideal harmonic, and selecting a best scoring harmonic is selected for resynthesis.

8. The method of claim 5 wherein recombining the high frequency portion of the voice signal with the amplified harmonics comprises:
combining the amplified harmonics with a portion of the monophonic input signal having frequency components above the HCF; and
converting the signal back to the time domain.

9. The method of claim 8 wherein the time domain output is generated by performing an inverse fast fourier transform (FFT) on the combined amplified harmonics and high frequency components of the monophonic input signal above the HCF.

10. The method of claim 9 and further comprising performing a crossover fade between the amplified harmonics and the high frequency components of the monophonic input signal above the HCF.

11. A machine-readable storage device having instructions for execution by a processor of a machine to cause the processor to perform operations to perform a method, the operations comprising:
receiving a monophonic voice signal;
classifying a frame of input as voiced or unvoiced;
detecting a fundamental frequency signal from the voice signal;
identifying harmonics of the fundamental frequency signal;
generating an interface to receive adjustable amplification coefficient selections for the harmonics;
amplifying the harmonics with received amplification coefficient selections; and
recombining high frequency noise components of the voice signal with the amplified harmonics.

12. The device of claim 11 wherein detecting the fundamental frequency of vocal signal is performed using one or more of:
an average magnitude difference function;
an autocorrelation function;
spectral template matching on a magnitude spectrum of the signal; or
pitch detection by peak-picking in a cepstral domain.

13. The device of claim 12 wherein pitch detection is preceded by digitizing an analog voice signal and processing overlapping blocks or frames of samples.

14. The device of claim 11 wherein identifying harmonics comprises dividing the frequency of sinusoids with a frequency below the harmonic cutoff frequency (HCF) by the fundamental frequency and rounding to the nearest integer.

15. The device of claim 14 wherein identifying harmonics further comprises comparing and scoring sinusoids that are assigned to the same harmonic number by their relative amplitude and proximity in frequency to an ideal harmonic, and selecting a best scoring harmonic is selected for resynthesis.

16. The device of claim 14 wherein recombining the high frequency portion of the voice signal with the amplified harmonics comprises:
combining the amplified harmonics with a portion of the monophonic input signal having frequency components above the HCF; and
converting the signal back to the time domain.

17. The device of claim 16 wherein the time domain output is generated by performing an inverse fast fourier transform (FFT) on the combined amplified harmonics and high frequency components of the monophonic input signal above the HCF.

18. A device comprising:
a processor; and
a memory device coupled to the processor and having a program stored thereon for execution by the processor to perform operations comprising:
receiving a monophonic voice signal;
classifying a frame of input as voiced or unvoiced;
detecting a fundamental frequency signal from the voice signal;
identifying harmonics of the fundamental frequency signal;
generating an interface to receive adjustable amplification coefficient selections for the harmonics;
amplifying the harmonics with received amplification coefficient selections; and
recombining high frequency noise components of the voice signal with the amplified harmonics.

19. The device of claim 18 wherein detecting the fundamental frequency of vocal signal is performed using one or more of:
an average magnitude difference function;
an autocorrelation function;
spectral template matching on a magnitude spectrum of the signal; or
pitch detection by peak-picking in a cepstral domain.

20. The device of claim 19 wherein identifying harmonics comprises:
dividing the frequency of sinusoids with a frequency below the harmonic cutoff frequency (HCF) by the fundamental frequency;
rounding to the nearest integer and comparing and scoring sinusoids that are assigned to the same harmonic number by their relative amplitude and proximity in frequency to an ideal harmonic; and
selecting a best scoring harmonic is selected for resynthesis, and wherein recombining the high frequency portion of the voice signal with the amplified harmonics comprises:
combining the amplified harmonics with a portion of the monophonic input signal having frequency components above the HCF; and
converting the signal back to the time domain.
